(19) United States
(12) Patent Application Publication
(10) Pub. No.: US 2026/0126145 A1
(43) Pub. Date: May 7, 2026

(54) PIPE FITTING FOR A FLUID COLLECTION WORKSTATION

(71) Applicant: Getty Box Pro LLC, Dickinson, ND (US)

(72) Inventor: Arthur Mark Hovde, Dickinson, ND (US)

(21) Appl. No.: 19/346,451

(22) Filed: Sep. 30, 2025

Related U.S. Application Data
(60) Provisional application No. 63/701,158, filed on Sep. 30, 2024.

(51) Int. Cl. F16L 55/115; F16K 21/00; G01N 1/10

(52) U.S. Cl. CPC F16L 55/1157; F16K 21/00; G01N 1/10

(57) ABSTRACT

Concepts presented herein relate to a pipe fitting cap for a containment assembly. In one embodiment, the cap is attached to an open end of a pipe positioned within the containment assembly. The cap is configured to fit over the open end and includes an integrated valve assembly that allows for controlled flow of fluid through the cap.

### BACKGROUND

Current load line containment assemblies are used in transferring fluid (e.g., oil, water, liquids, condensate) from a first container to a second container. These assemblies include a lid and a container for receiving one or more connections. Current assemblies include connections to both a supply line and a transfer line. In some instances, users of the assemblies use one or more tools and/or fittings in connecting a line to the containment assembly and facilitating testing of fluid within the containment assembly.

### SUMMARY

Concepts presented herein relate to a pipe fitting cap for a containment assembly. In one embodiment, the cap is attached to an open end of a pipe positioned within the containment assembly. The cap is configured to fit over the open end and includes an integrated valve assembly that allows for controlled flow of fluid through the cap.

### BRIEF DESCRIPTION OF THE DRAWINGS

FIG. 1 is a perspective view of a containment assembly.

FIG. 2 is a schematic side view of a pipe fitting cap.

### DESCRIPTION

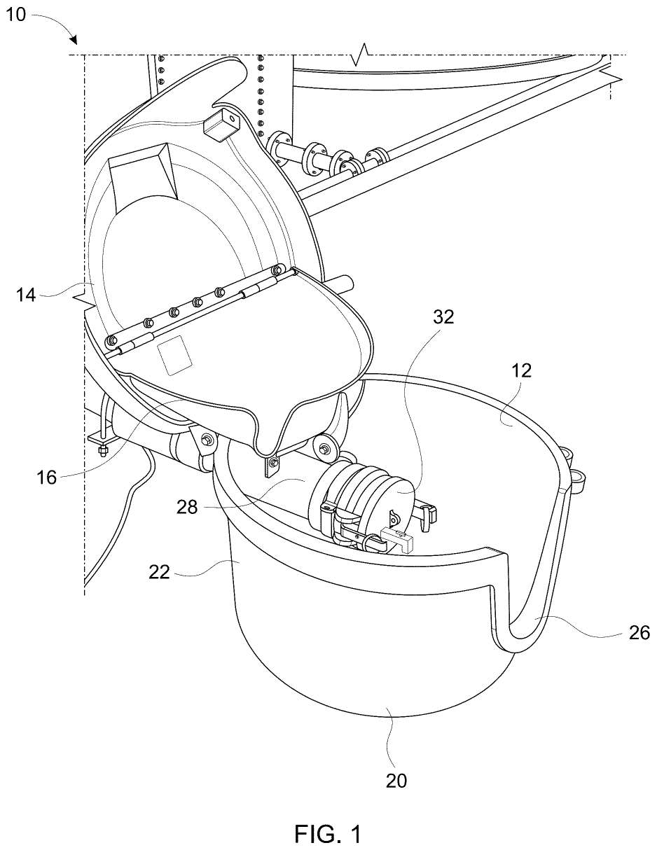

FIG. 1 is a perspective views of an example load line containment assembly 10. Containment assembly 10 includes a container 12, a lid 14 and a tool storage device 16. In some embodiments, tool storage device 16 can be eliminated. Assembly 10 is configured to accept connections thereto when loading/unloading fluid such as oil, acid, water and/or hazardous waste from/to a vessel (e.g., a storage container, tank truck). In the embodiment illustrated, the lid 14 and tool storage device 16 are coupled together and configured to pivot with respect to the container 12. As discussed below, the containment assembly 10 can be used as a workstation for collection of samples from the container 12 and storage of testing devices onto the tool storage device 16. Further, a fluid delivery component can be incorporated into the tool storage device 16 and connected to the lid 14 to direct oil from an interior side of the lid to the container 12. In one embodiment, containment assembly 10 can include features as disclosed in U.S. Pat. No. 9,151,428, the contents of which are hereby incorporated by reference in their entirety.

Container 12 in one embodiment is formed of a unitary body, which forms a bottom 20 surrounded by an upwardly extending wall 22. The wall 22 extends from the bottom 20 to an upward opening 24 and further defines a line support 26 and a collar support 28. The collar support 28, in one embodiment, forms a pipe terminating at an open end that receives a first connection (e.g., from a supply line) and a second connection (e.g., from a transfer line). The container 12 further defines a hinge assembly connecting container 12 and lid 14.

When placed in service, assembly 10 is generally used in the transfer of fluid from a first tank (e.g., a storage tank at an oil field) to a second tank (e.g., a mobile tank positioned on a truck). The assembly 10 can be positioned in the closed configuration when not in use, whereby the lid 14 protects unwanted contaminants (e.g., dirt, leaves, birds, rodents) from entering container 12. A first line (e.g., a supply line or the like connected with a storage tank) is fluidly connected with the collar support 28 to supply fluid (e.g., oil) to the assembly 10. A transfer line (e.g., a hose or the like connected with a mobile tank) passes through the line support 26 and connects with the collar support 28, fluidly connecting the supply line and the transfer line. Coupled with the collar support 28 is a pipe fitting cap 32. Cap 32 can be used to obtain samples of fluid received from the supply line, as will be discussed below.

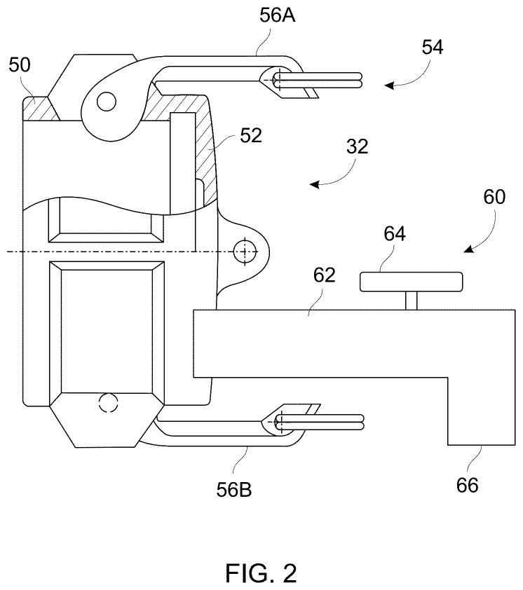

Collar support 28 is cylindrical and extends into container 12. With further reference to FIG. 2, cap 32 includes an annular wall 50 shaped to fit over and cover an open end of collar support 28 and an end wall 52 connected to the annular wall 50 to prevent fluid leakage when secured to collar support 28. In one embedment, cap 32 is constructed from a durable, corrosion-resistant material such as stainless steel, PVC, or brass. Cap 32 further includes an attachment mechanism 54 adapted to secure cap 32 to the end of collar support 28. Any type of attachment mechanism can be used to secure cap 32 to collar support 28, such as clamps and threads. In the illustrated embodiment, attachment mechanism 54 includes opposed cam lock arms 56A and 56B that can be rotated relative to the cap 32 and secure cap 32 to collar support 28.

To facilitate sampling from container 12 (i.e., access to fluid within collar support 28), cap 32 incorporates a valve assembly 60 that can be selectively operated to allow fluid to flow through cap 32. As illustrated, valve assembly 60 is positioned within end wall 52. A valve mechanism for valve 60 can be a ball valve, gate valve, or other suitable valve type, designed to open or close fluid flow through cap 32. Valve assembly 60 includes a proximal segment 62 extending through end wall 52, an actuator 64 (e.g., a handle, lever) that allows a user to open or close fluid flow through cap 32 via a valve mechanism and a distal opening 66. Valve assembly 60 is illustrated as being positioned to one side of cap 32, but in other embodiments can be positioned centrally within end wall 52 or in other positions as desired.

In one method of use, a user can use valve assembly 60 in obtaining samples for testing during loading fluid onto a truck, trailer or vessel. A user approaches containment assembly 10 and prepares to transfer fluid through the containment assembly 10 to the truck, trailer or vessel. The user can then obtain a sample by positioning valve assembly 60 in an open position, for example by operating actuator 64. When valve assembly 60 is in an open position, fluid flows from collar support 28 through segment 62 and exits valve assembly 60 through distal opening 66. A sampling device (e.g., a bottle) can be positioned under the distal opening 66 to collect a sample. Fluid from the sampling device can then be transferred to a testing device such as a woodback thermometer or hydrometer floating within a thief. The testing devices can be supported by storage device 16 to allow completion of testing while fluid is still flowing to the truck. The sampling and testing process can be completed multiple times as desired to obtain and test multiple samples using valve assembly 60.

Cap 32 can be useful in systems where temporary access to fluid in a pipe is needed, without requiring removal of the cap 32. Valve assembly 60 allows for easy and efficient transfer of fluid within collar support 28 such that a user can obtain samples for testing.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A cap, comprising:
an annular wall adapted to be positioned over an open end of a pipe;
an end wall connected to the annular wall; and
a valve assembly positioned in the end wall and configured to be selectively operated to allow fluid to flow through the end wall to a distal opening.

2. The cap of claim 1, wherein the valve assembly includes an actuator operable to selectively open and close fluid flow through the valve assembly.

3. The cap of claim 1, further comprising an attachment mechanism operable to secure the cap to the open end of the pipe.

4. A containment assembly, comprising:
a container;
a lid pivotally connected to the container through a hinge and configured to be positioned in an open configuration and a closed configuration;
a pipe extending through the container and terminating at an open end; and
a cap including an annular wall, an end wall and a valve assembly, the annular wall extending around the open end of the pipe and the end wall covering the open end of the pipe.

5. The containment assembly of claim 4, wherein the valve assembly allows flow of fluid from the open end of the pipe to a distal opening.

6. A method of testing a sample of fluid from a containment assembly, comprising:
accessing a cap positioned over an open end of a pipe within the containment assembly; and
operating a valve assembly on the cap to allow fluid to flow through the cap to a distal opening.

7. The method of claim 6, wherein operating the valve assembly includes operating an actuator.

8. The method of claim 6, further comprising positioning a sampling device beneath the distal opening to collect a fluid sample for testing.

9. The method of claim 8, further comprising transferring the fluid sample to a testing device supported by the containment assembly.

10. The method of claim 6, wherein the cap includes opposed cam lock arms configured to secure the cap to the pipe.
